(19) United States
(12) Patent Application Publication
(10) Pub. No.: US 2010/0305813 A1
(43) Pub. Date: Dec. 2, 2010

(54) ELECTRONIC LOGBOOK

(76) Inventor: Henryk Bury, Loehne (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/789,736

(22) Filed: May 28, 2010

(30) Foreign Application Priority Data
May 29, 2009 (DE) 10 2009 023 639.2

(51) Int. Cl. G06F 19/00; G07C 5/00

(52) U.S. Cl. 701/35

(57) ABSTRACT

An electronic logbook in an appliance (1) which can be used removably in a vehicle holder (2), containing a satellite position-finding module (22) for reception of satellite data and for outputting position data, derived from the satellite data, and time data, an association device for association of mutually associated position and time data, and a non-volatile memory device for the associated position and time data, wherein the electronic stages in the housing are supplied with electricity via a connection from an on-board power supply system in the vehicle, can be protected against manipulation by removal of the appliance (1) from the vehicle holder (2) in that, when the appliance is disconnected from the on-board power supply system, a residual power supply is provided which keeps the appliance (1) operable for a short time and controls immediate storage of the most recently determined position and time data with a marking, in that, when the appliance (1) is inserted into the vehicle holder (2), a clock with a fictitious starting time is controlled,

in that, when satellite data is received again, position data and current time data are determined, and in that the time which has passed on the clock before determination of the current time data is used to determine the time when the appliance (1) was inserted into the vehicle holder (2).

The invention relates to an electronic logbook in a housing which can be used removably in a vehicle holder, containing a satellite position-finding module for reception of satellite data and for outputting position data, derived from the satellite data, and time data; an association device for association of mutually associated position and time data, and a non-volatile memory device for the associated position and time data, wherein the electronic stages in the housing are supplied with electricity via a connection from an on-board power supply system in the vehicle.

It may be necessary, or at least advantageous, for many reasons to maintain a logbook for a motor vehicle. For motor vehicles which are used for both business and private purposes, the logbook can be used as a verification means for the proportion of business use.

Electronic logbooks are particularly advantageous, by means of which not only the data recorded for a manual logbook, such as the mileage at the start and end of the journey, the time of the start and end of the journey and the purpose of the journey, are available, but data for complete reconstruction of the journey made, including any rest pauses, is stored, in such a way that, if required, this could be played back on a computer, where it can be evaluated. The housing is accordingly designed such that it can easily be removed from the vehicle holder in order to allow it to be taken to a computer where the stored data is transferred such that the memory device in the electronic logbook can be emptied, such that the entire capacity of the memory device is available for recording new data.

One problem with electronic logbooks such as these is that specific processes are not stored, by manipulation of the appliance, and it may also not be possible to verify such manipulation later. By way of example, attempts may be made to suppress the recording of data in the memory device of the electronic logbook by removing the electronic logbook from the vehicle holder, as a result of which it is no longer connected to a supply voltage. Since, for cost reasons, the appliance is not provided with its own power supply, the fact of manipulation cannot be identified.

The present invention is based on the object of designing an electronic logbook of the type mentioned initially such that the possibilities for manipulation of the appliance are at least reduced.

According to the invention, this object is achieved by an electronic logbook of the type mentioned initially, characterized in that, when the appliance is disconnected from the on-board power supply system, a residual power supply is provided which keeps the appliance operable for a short time and controls immediate storage of the most recently determined position and time data with a marking, in that, when the appliance is inserted into the vehicle holder, a clock with a fictitious starting time is controlled, in that, when satellite data is received, position data and current time data are determined, and in that the time which has passed on the clock before determination of the current time data is used to determine the time when the appliance was inserted into the vehicle holder.

The electronic logbook according to the invention therefore requires neither its own power supply nor its own means of determining the real time, thus avoiding any additional complexity resulting from such functional modules. The residual power supply, which can be provided by a capacitor of suitably large capacitance, keeps the appliance still operable for a short time after the appliance has been disconnected from the on-board power supply system, and causes the most recently determined position and time data to be immediately recorded together with a marking which characterizes the process of the appliance being disconnected from the on-board power supply system. A special process is therefore retained in the electronic logbook, specifically the process of disconnection of the appliance from the on-board power supply system by removal of the appliance from the vehicle holder.

When the appliance is inserted into the vehicle holder again, the appliance may not receive any satellite data, for example because the vehicle is parked in a poor position. When the appliance is inserted into the vehicle holder, a time measurement is started by controlling a clock with a fictitious starting time, wherein the clock acts only as a time measurement device. When satellite data is now received, for example after movement of the vehicle, the appliance records the position data, derived from the satellite data, and current time data. The time measured by the clock is now correlated with the current time data, as a result of which it is possible to determine the actual time when the appliance was reinserted into the holder, even though the appliance does not have its own power supply. In consequence, it is possible to use the logbook to store times of disconnection of the appliance from the on-board power supply system, which is equivalent to the removal of the appliance from the vehicle holder, and the reinsertion of the appliance into the vehicle holder, and, when the data from the appliance is played back on a computer, to allow evaluation and reconstruction of the processes on a business journey. The risk of manipulation by removal of the appliance from the holder is thus reduced, because the fact that the appliance has been removed from the holder on the one hand and the times at which the appliance was removed and reinserted are documented.

In one preferred embodiment of the invention, the electronic logbook is provided with a switch by means of which a journey with the motor vehicle can be marked as a business journey or a private journey. Different data sets are therefore stored in the memory device. When the appliance is in the working mode for a private journey, the position and time data which allow virtually complete reconstruction of the journey carried out are not stored. In the private journey mode, it is sufficient for the time and the position at the start and at the end of the private journey to be stored. In one embodiment which is preferred for this purpose, the position data is not stored in the memory device, but is evaluated in order to determine the length of the route travelled, and the route travelled is stored as data.

In one preferred embodiment of the invention, the housing has a mechanically operable switch which is arranged such that it is operated on insertion into the holder or on removal from the holder. The signal from this switch can be used to mark the process of removal and reinsertion in the stored position and time data.

When the housing which can be inserted into the vehicle holder is in the form of an appliance with a display which can be read in the inserted state, the electronic logbook can be used in particular to output warning signals. For this purpose, the appliance which can be inserted into the vehicle holder is provided with a memory in which position data for danger points or those points which require particular care are stored. In this case, in particular, schools, care homes for the elderly, hospitals, etc. may be entered as danger points, where a greater number of pedestrians, with slowly moving or inattentive pedestrians, can be expected. By way of example, further stored danger points may be accident black spots, as well as those accident black spots which are monitored by radar checks for a maximum speed. When using a display appliance, it is in this case possible to show the maximum permissible speed at the danger point on the display, for the information of the driver. In addition to showing a warning signal on the display, the appliance is preferably equipped with a buzzer, which also emits an audible warning signal.

The memory device is preferably formed by a memory card which can be inserted into a holding slot in the housing. In order to reduce a manipulation capability, it may in this case be expedient for the holding slot for the memory card to be designed such that it can be locked after insertion of the card, such that the lock can be removed only by destroying it. A destroyed holding slot lock therefore indicates that the memory card has been removed, that is to say impermissible manipulation.

The electronic logbook according to the invention may furthermore be in the form of an appliance of a hands-free device for a mobile radio. For this purpose, the appliance is preferably provided with a wire-free, short-range communication device, by means of which signals can be transmitted in a wire-free manner using an appropriately designed mobile radio, in particular to the Bluetooth Standard, such that a telephone call received via the mobile radio can be handled via the appliance, for example by showing the telephone number or the previously stored call subscriber in the appliance display and by the vehicle holder being provided with or connected to a loudspeaker and a microphone, such that the telephone call can be handled acoustically using the appliance inserted into the holder, as a hands-free device.

The electronic logbook designed according to the invention can also be provided with an evaluation device, by means of which the instantaneous speed of the motor vehicle is determined from the determined current position and time data. This can be compared with a preset or stored maximum speed, such that the appliance can also emit a warning signal when the currently measured speed of the motor vehicle exceeds a preset or stored maximum speed.

The invention will be explained in more detail in the following text with reference to one exemplary embodiment, which is illustrated in the drawing, in which:

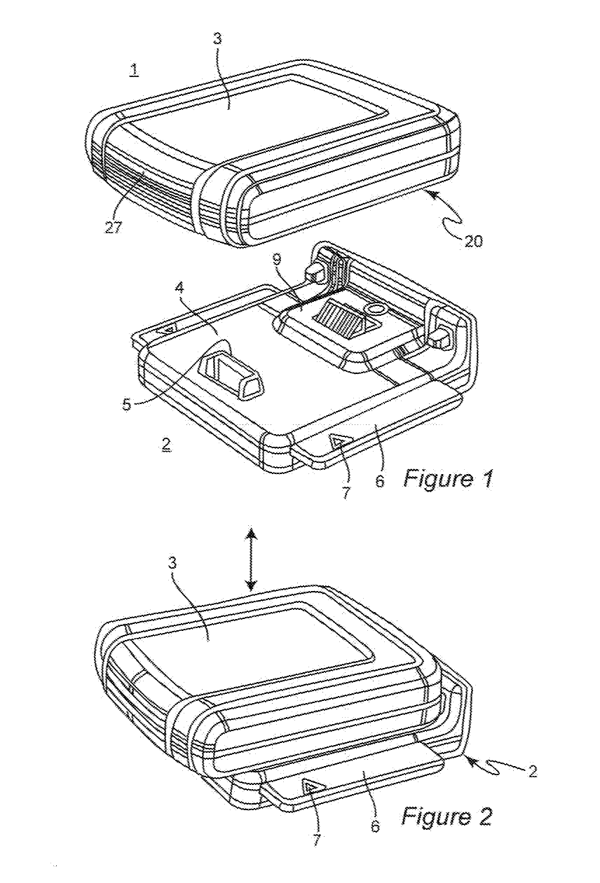

FIG. 1 shows a perspective illustration of a vehicle holder and of an appliance housing which has not yet been inserted into the vehicle holder;

FIG. 2 shows the perspective view from FIG. 1, with the appliance having been inserted such that it is latched in the vehicle holder;

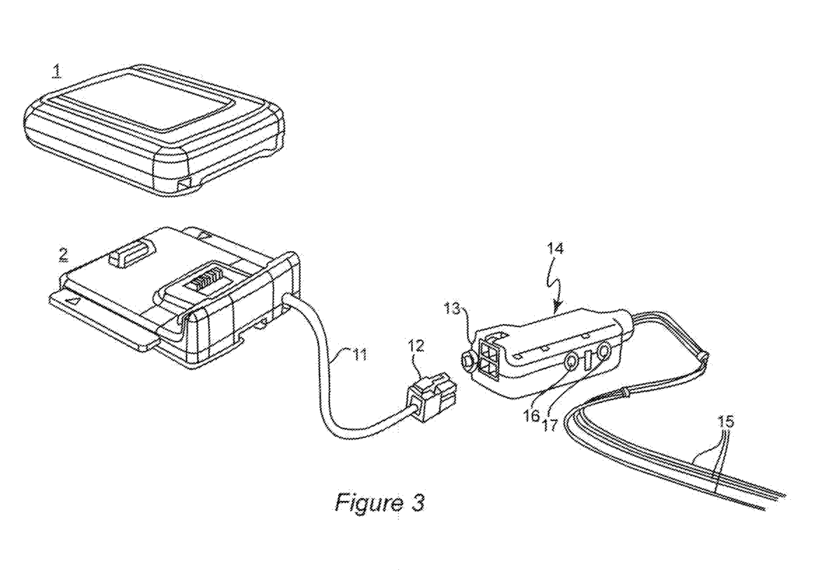

FIG. 3 shows a perspective illustration of the vehicle holder with the appliance not yet having been inserted, and with a cable connection between the vehicle holder and a connecting box;

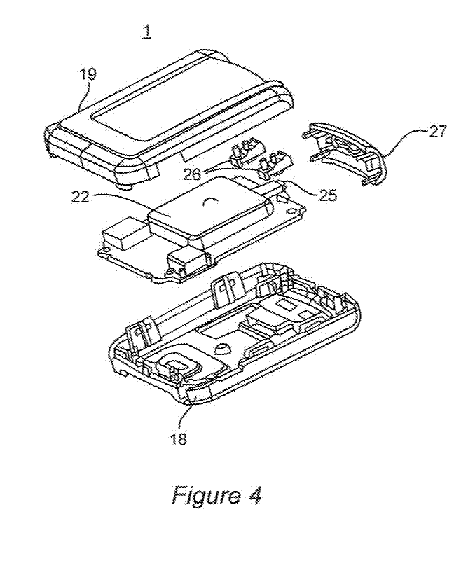

FIG. 4 shows an exploded illustration of the parts of the appliance; and

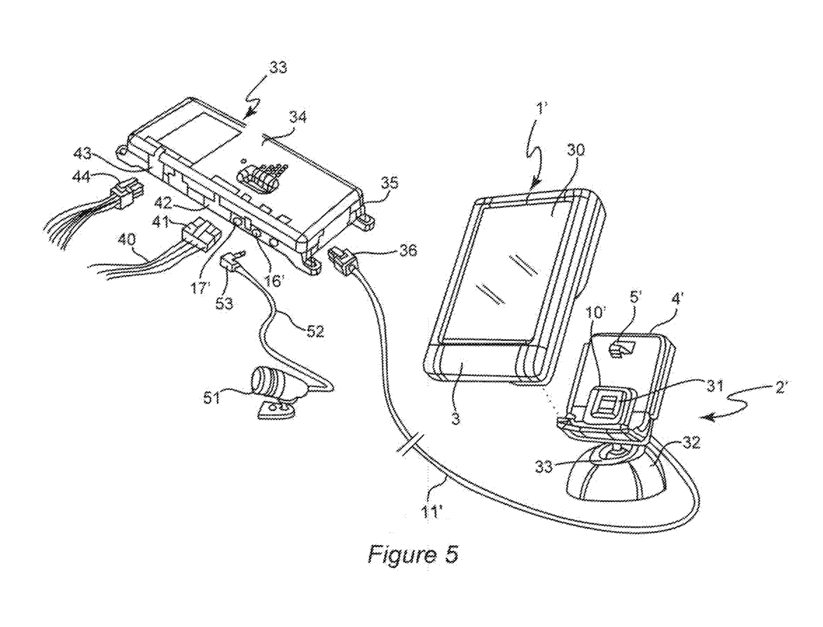

FIG. 5 shows a perspective illustration corresponding to FIG. 3 of a further embodiment of an appliance according to the invention.

FIG. 1 shows an appliance 1 which can be inserted, such that it is locked, into a vehicle holder 2 which is permanently installed in a vehicle (which is not illustrated). The appliance 1 is in the form of a flat appliance with a large front face 3.

The vehicle holder 2 essentially comprises a panel 4 on which the appliance 1, which is substantially rectangular and is thin, rests when it has been inserted into the vehicle holder 2. A spring-mounted locking hook 5 projects from the surface of the panel 4 and can be snapped, such that it is locked, into a recess (which is not illustrated), provided with an undercut, on the rear face of the appliance 1. Unlocking strips 6 which are arranged at the side on the vehicle holder 2 can be pushed inwards against the force of a resetting spring (which is not illustrated) in the direction of the arrows 7 printed thereon for the purpose of unlocking for removal of the appliance 1 from the vehicle holder.

A web 8 which projects at right angles to the surface of the panel 4 and on which the corresponding narrow lower edge of the appliance 1 rests when the appliance 1 has been inserted into the vehicle holder 2 is located on the lower face of the vehicle holder 2. A plateau 9, which is like a pedestal, is located above the web 8 on the panel 4, from which plateau 9 sprung contacts 10 project at right angles to the surface of the plateau 9. These contacts 10 make contact with corresponding mating contacts (which are not illustrated) on the rear face of the appliance 1 when the latter has been inserted into the vehicle holder 2.

FIG. 2 shows the state in which the appliance 1 has been inserted into the vehicle holder 2.

As can be seen from FIG. 3, the vehicle holder 2 can be connected to a connecting box 14 by means of a connecting cable 11 with a plug 12 which can be plugged into a corresponding plug receptacle 13. Control lines 15 are connected to the connecting box 14, via which control signals are passed from the motor vehicle to the connecting box 14, or from the connecting box 14 to electronic devices in the motor vehicle.

In one preferred embodiment of the invention, the appliance 1 is in the form of a controller for a hands-free device and can communicate with mobile telephones via a short-range radio link, in particular to the Bluetooth Standard. In this case, the car radio of the motor vehicle can be muted when there is an incoming call via one of the control lines, so as not to interfere with the call. The connecting box 14 furthermore has connecting sockets 16, 17 via which a microphone which is installed in the vehicle and a loudspeaker device which is installed in the vehicle can be connected, such that an incoming telephone call to the mobile telephone can be handled via the appliance 1, which acts as a controller for the hands-free device, and the vehicle holder 2 and the connecting box 14 in the hands-free mode.

FIG. 4 schematically illustrates the internal design of the appliance 1. This comprises a lower housing shell 18 and an upper shell 19 which forms the front face, and which together form the housing 20 of the appliance 1. A printed circuit board 21 can be attached to the lower housing shell 18, on which printed circuit board 21 a satellite data module with an antenna 22 for reception of the satellite data, a controller 23 with a buzzer for audible warning signals, a mini-USB connection 24 and an operating-mode changeover switch 25 as well as two light-emitting diodes 26 for status indication are located. The housing can be completed by an at least partially transparent housing cap 27 on the upper edge of the appliance 1. The status indication of the light-emitting diodes can be seen through the transparent housing cap 27.

The satellite data module 22 contains an evaluation device for determining position data and time data from the received satellite data, as well as the association device for association of the mutually associated position and time data, and a memory device for storage of this associated data, such that the data required for a logbook is available in a stored form. This data can be played back on a computer via the mini-USB connection 24 after the end of the journey, and can be processed further by software that is suitable for this purpose, in order to form a logbook record.

In the further exemplary embodiment of the invention, as illustrated in FIG. 5, the appliance 1′ is provided on its front face 3 with a display 30 which extends over virtually all the front face 3. A vehicle holder 2′ is formed in a similar manner to the vehicle holder 2 with a panel 4′, a locking hook 5′, a plateau 9′ like a pedestal and contacts 10′, such that the appliance 1′ rests on the panel 4′, and makes contact with it, in a comparable manner to the appliance 1. In this embodiment, the vehicle holder 2′ is formed from two parts, specifically with a holding part 31 which has the panel 4′ and an attachment foot 32, on which the holding part 31 is mounted, such that it can be adjusted, via a ball bearing 33.

In this case, the hands-free device has a central controller 33 with a housing 34. The holding part 31 is connected via a connecting cable 11′ to the central controller 33, via a plug connection 35 and via an associated plug 36. The housing 34 of the central controller 33 has sockets 16′, 17′ whose functions correspond to the sockets 16, 17. In consequence, a microphone 37 can be inserted into the socket 16′, via a microphone cable 38 and a mating plug 39. Instead of the direct connection of a loudspeaker to the socket 17′, a multimedia cable 40 can in this case be inserted with a plug 41 and a plug connection 42, via which the telephone call can be reproduced via the loudspeaker which is installed in the vehicle and is connected to a multimedia arrangement via a bus. A plug input 43 is used to hold a plug 44 in particular for supplying muting and ignition-state signals relating to the motor vehicle, such as those which are normally supplied for a hands-free device.

The display 30 of the appliance 1′ is preferably in the form of a touchscreen when the aim is also to control the appliance 1′, or appliances connected to it, via the display.

1. Electronic logbook in an appliance (1) which can be used removably in a vehicle holder (2), containing a satellite position-finding module (22) for reception of satellite data and for outputting position data, derived from the satellite data, and time data, an association device for association of mutually associated position and time data, and a non-volatile memory device for the associated position and time data, wherein the electronic stages in the housing are supplied with electricity via a connection from an on-board power supply system in the vehicle, characterized in that, when the appliance is disconnected from the on-board power supply system, a residual power supply is provided which keeps the appliance (1) operable for a short time and controls immediate storage of the most recently determined position and time data with a marking,
in that, when the appliance (1) is inserted into the vehicle holder (2), a clock with a fictitious starting time is controlled,
in that, when satellite data is received again, position data and current time data are determined, and in that the time which has passed on the clock before determination of the current time data is used to determine the time when the appliance (1) was inserted into the vehicle holder (2).

2. Electronic logbook according to claim 1, characterized in that the appliance (1) has an operating mode changeover switch (25) for setting a “private journey” or “business journey” operating mode.

3. Electronic logbook according to claim 1, characterized in that the position data is evaluated in order to determine the route travelled, and the length of the route travelled is stored.

4. Electronic logbook according to claim 1, characterized in that the appliance (1) has a mechanically operable switch which is arranged such that it is operated on insertion into the vehicle holder (2) or on removal from the vehicle holder (2), respectively.

5. Electronic logbook according to claim 1, characterized in that the appliance is in the form of a display appliance with a display (3) which can be read in the state in which it is inserted into the vehicle holder (2).

6. Electronic logbook according to claim 1 characterized in that the appliance (1) is designed to output warning signals.

7. Electronic logbook according to claim 1, characterized in that the memory device is formed by a memory card inserted into the appliance (1).

8. Electronic logbook according to claim 5, characterized in that the processing stage for the satellite position-finding module (22) is designed to determine a current speed of the vehicle, and in that the determined current speed can be displayed via the display (3).
